(19) United States
(12) Patent Application Publication
(10) Pub. No.: US 2023/0282904 A1
(43) Pub. Date: Sep. 7, 2023

(54) BATTERY PACK WITH BATTERY CONTAINMENT SYSTEM COOLING GAS EXHAUSTED BY LITHIUM-ION BATTERY DURING THERMAL RUNAWAY CONDITION

(71) Applicant: Thales Avionics, Inc., Irvine, CA (US)

(72) Inventors: Deo M. MAGAKAT, Colton, CA (US); Derek NGUYEN, San Clemente, CA (US); Ton DO, Corona, CA (US); Tony NGUYEN, Buena Park, CA (US)

(21) Appl. No.: 17/687,982

(22) Filed: Mar. 7, 2022

(51) Int. Cl. H01M 10/6556; H01M 10/613; H01M 10/653; H01M 50/358; H01M 10/625

(52) U.S. Cl. CPC H01M 10/6556; H01M 10/613; H01M 10/625; H01M 10/653; H01M 50/358; H01M 2220/20

(57) ABSTRACT

Some embodiments of the present disclosure relate to a battery containment assembly for powering an electronic device. The battery containment assembly including at least one lithium-ion battery. The battery containment assembly includes a battery casing enclosing the at least one lithium-ion battery and having a cooling channel extending from a vent of the battery casing to the at least one lithium-ion battery, the cooling channel configured to vent any gas exhausted by the at least one lithium-ion battery to mix with air outside of the battery casing and to lower a temperature of the gas exhausted from the at least one lithium-ion battery during a thermal runaway condition of the at least one lithium-ion battery before the gas exits the vent.

### FIELD OF THE INVENTION

The present disclosure relates to in-flight entertainment systems that include rechargeable tablet computers for use by passengers and crew during flight.

### BACKGROUND

The increasing popularity of personal electronic devices (PED) means that passengers are accustomed to relying on their smartphones, tablets and other portable devices for more and more day-to-day activities. Travelers are increasingly expecting airlines to provide in-flight entertainment systems that replicate or even transcend the PED based experience they have on the ground. Airlines are responding with more elaborate entertainment options which include handing out tablets that are pre-loaded with entertainment content and may also be preconfigured to utilize aircraft satellite communications to access content streaming and other services from ground-based network servers.

Lithium-ion (Li-ion) batteries are the predominate type of rechargeable power source for tablet and other rechargeable electronic devices because of their high power densities, fast charging capabilities, long service life, etc. Fire is a well-known risk associated with Li-ion batteries which is triggered by thermal runaway. Because of the extremely danger presented by fire onboard an aircraft, design considerations for Li-ion batteries for use onboard aircraft prioritize preventing thermal runaway from occurring.

Thermal runaway occurs when a cell, or area within the cell, achieves elevated temperatures due to thermal failure, mechanical failure, internal/external short circuiting, and electrochemical abuse. At elevated temperatures, exothermic decomposition of the cell materials begins. Eventually, the self-heating rate of the cell causes cell temperature to rise exponentially, and stability is ultimately lost. The loss in stability results in all remaining thermal and electrochemical energy being released to the surroundings.

Therefore, there exists a need to provide safer battery pack configurations for use in electronic devices for aircraft applications.

### SUMMARY

Some embodiments of the present disclosure are directed to a battery containment assembly for powering an electronic device. The battery containment assembly includes at least one lithium-ion battery. The battery containment assembly further includes a battery casing enclosing the at least one lithium-ion battery and having a cooling channel extending from a vent of the battery casing to the at least one lithium-ion battery. The cooling channel is configured to vent any gas exhausted by the at least one lithium-ion battery to mix with air outside of the battery casing and to lower a temperature of the gas exhausted from the at least one lithium-ion battery during a thermal runaway condition of the at least one lithium-ion battery before the gas exits the vent.

Potential advantages of these embodiments include that the cooling channel is configured to sufficiently cool lithium gas exhausted by the battery during a thermal runaway condition to avoid ignition of the lithium gas when exposed to oxygen in the ambient air outside the battery containment assembly, and thereby substantially reduce the risk of fire.

It is noted that aspects described with respect to one embodiment may be incorporated in different embodiments although not specifically described relative thereto. That is, all embodiments and/or features of any embodiments can be combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 illustrates an isometric view of some components of a battery containment assembly, with a cover removed, for powering an electronic device in accordance with some embodiments of the present disclosure;

FIG. 2 illustrates an isometric view of the battery containment assembly of FIG. 1 with the cover installed, and being attached to an electronic device casing in accordance with some embodiments of the present disclosure;

FIG. 3 illustrates a disassembled view of the battery containment assembly showing various components configured in accordance with some embodiments of the present disclosure;

FIG. 4 illustrates a top view of the battery containment assembly of FIG. 1 configured in accordance with some embodiments of the present disclosure;

FIG. 5 illustrates a disassembled view of an alternative configuration of a battery containment assembly showing various components configured in accordance with some embodiments of the present disclosure;

FIG. 6 illustrates a schematic side view of a cooling channel configured with a serpentine shaped gas flow pathway in accordance with some embodiments of the present disclosure; and

FIG. 7 illustrates a schematic isometric view of a cooling channel configured with a spiral shaped structure to create a spiral gas flow pathway in accordance with some embodiments of the present disclosure.

### DETAILED DESCRIPTION

In the following detailed description, numerous specific details are set forth in order to provide a thorough understanding of embodiments of the present disclosure. However, it will be understood by those skilled in the art that the present invention may be practiced without these specific details. In other instances, well-known methods, procedures, components and circuits have not been described in detail so as not to obscure the present invention. It is intended that all embodiments disclosed herein can be implemented separately or combined in any way and/or combination.

Any rechargeable lithium-ion battery pack in electronic devices installed on commercial airlines needs to meet the FAA DO-311A requirement of the thermal running away containment. FAA DO-311A defines requirements on electronic devices which when subjected to an explosive atmosphere within a battery compartment and when an ignition source is applied, the electronic device cannot show flames escaping from the electronic device.

When a lithium-ion battery cell is ignited, the flammable lithium-ion fluid in the battery cell reacts vigorously, generating high heat and sometimes producing a fire and potentially an explosion. Embodiments of the present disclosure are directed to providing a battery containment system that includes a cooling channel that is configured to duct gasses exhausted by a lithium-ion battery cell during a thermal runaway condition to a vent where the gasses to mix with air outside the battery containment system. The cooling channel is configured to sufficiently cool lithium gas exhausted by the battery during the thermal runaway condition to avoid ignition of the lithium gas when exposed to oxygen in the air outside the battery containment assembly, and thereby substantially reduce the risk of fire.

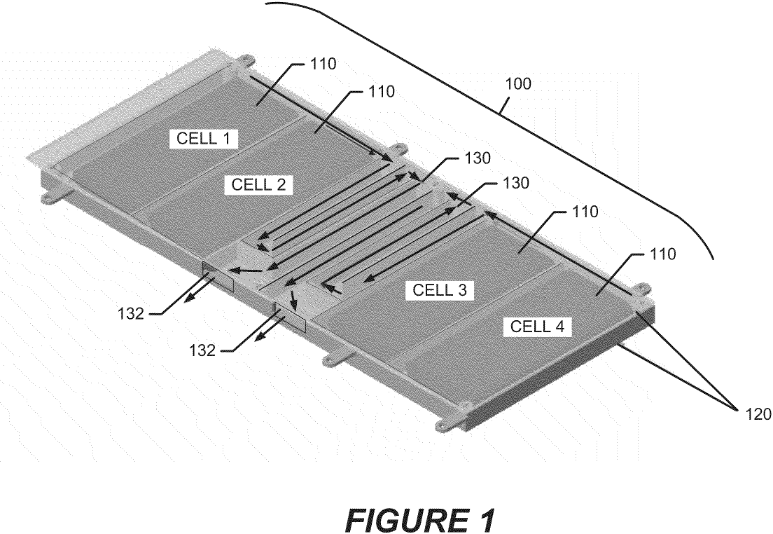

FIG. 1 illustrates an isometric view of some components of a battery containment assembly 100, with a cover removed, for powering an electronic device in accordance with some embodiments of the present disclosure.

Electronic devices which can use the battery containment system 100 can include, but are not limited to, a laptop computer, a tablet computer, mobile phone, e-reader, electronic data storage device, battery-power backup systems, etc.

Referring to FIG. 1, the battery containment assembly 100 includes at least one lithium-ion battery 110. Four lithium-ion battery cells are shown in the example of FIG. 1. The battery containment assembly 100 includes a battery casing 120 enclosing the at least one lithium-ion battery 110 and having a cooling channel 130 extending from a vent 132 of the battery casing 120 to the at least one lithium-ion battery 110. The cooling channel 130 ducts gasses which are exhausted by the lithium-ion battery(ies) 110 during a thermal runaway condition to the vent 132 where the gasses mix with air outside of the battery casing 120. The shape of the cooling channel 130 is configured to thermally interact with the gasses while flowing toward the vent 132, to thermally conduct a substantial amount of heat away from the hot gasses and sufficiently lower temperature their temperature before exiting the vent 132 so that the lithium gas does not ignite when exposed to oxygen in the air.

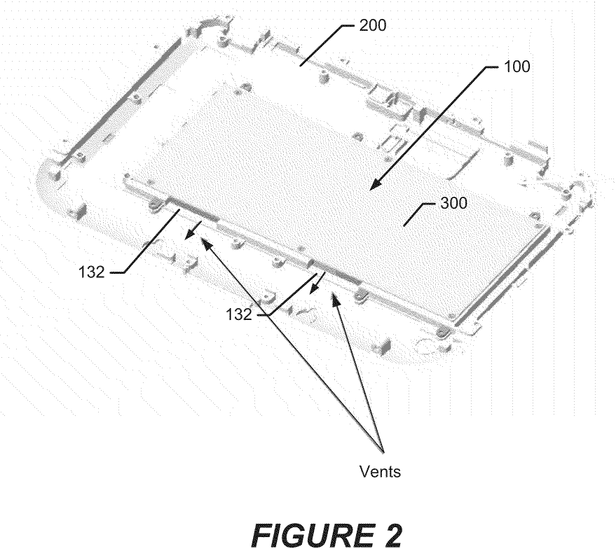

FIG. 2 illustrates an isometric view of the battery containment assembly 100 of FIG. 1 with the cover 300 installed, and being attached to an electronic device casing 200 in accordance with some embodiments of the present disclosure.

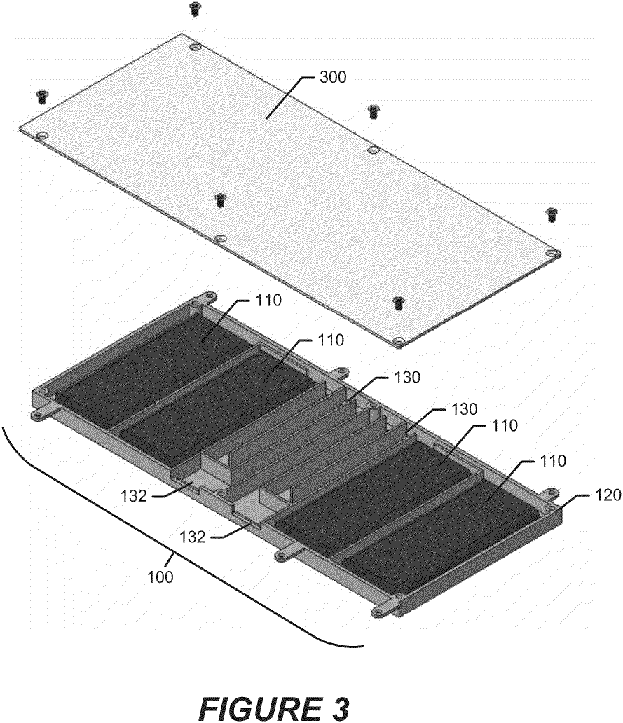

FIG. 3 illustrates a disassembled view of the battery containment assembly 100 showing various components configured in accordance with some embodiments of the present disclosure.

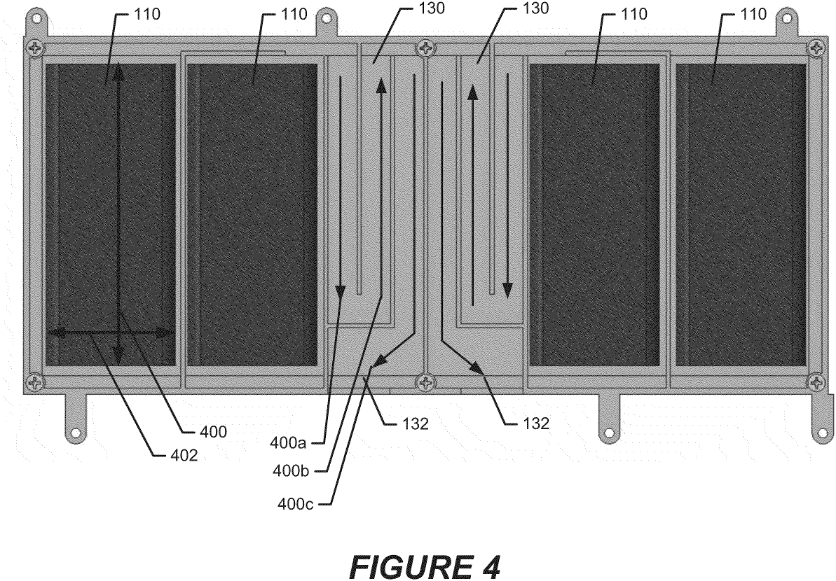

FIG. 4 illustrates a top view of the battery containment assembly 100 of FIG. 1 configured in accordance with some embodiments of the present disclosure. Referring to FIG. 4, each of the lithium-ion batteries 110 comprises a major dimension 400 and minor dimension 402, and a length of the cooling channel 130 extending from the battery 110 to the vent 132 extends at least as long as the minor dimension 402. In some embodiments, the length of the cooling channel 130 extends at least as long as the major dimension 400. In some embodiments, the length of the cooling channel 130 extends at least as long as triple the major dimension. As illustrated, the cooling channel 130 has a serpentine shaped gas flow pathway through which the gas flows toward the vent 132 to exhaust outside of the lithium-ion battery casing, the serpentine shaped gas flow pathway 600 which increases distance that the gasses flow from the batteries 110 to reach the vents 132 and which increases the heat transfer from the gasses to surfaces and structure of the cooling channel 130.

Potential advantages of these embodiments include avoiding ignition of the lithium gas and associated fire if the lithium-ion battery 110 experiences thermal runaway conditions. Thermal runaway of the lithium-ion battery 110 initiates an unstoppable chain reaction. The temperature rises rapidly within milliseconds and the energy stored in the battery is suddenly released. Temperatures of around 400° C. can be created, under which the lithium-ion battery 110 exhausts gasses that include lithium gas. The risk of thermal runaway for a lithium-ion battery 110 can begin at a battery temperature of 60° C. and becomes extremely critical at 100° C. Example causes of thermal runaway in a lithium-ion battery can include: an internal short circuit, an external short circuit of a device the battery is powering, overcharging the battery, or excessive currents when charging or discharging the battery.

In some embodiments, the cooling channel 130 is formed from a material and with a shape that is configured to perform substantial conductive heat transfer from the ducted gasses so the temperature of the gasses is cooled below a spontaneously combustion temperature of a lithium gas component when exhausted through the vents 132 and exposed to oxygen in the air outside the battery casing 120.

More particularly, in some embodiments, the cooling channel 130 is configured to cool the gas exiting the vent 132 to below 180° C. to prevent the lithium gas component of the gas from spontaneously combusting when exposed to oxygen in the air outside the battery casing 120.

In other words, some aspects of the present disclosure are directed to providing a sufficiently long pathway for the gas to exhaust from the battery 110 to the outside environment, so that heat transfer from the exhaust gases to the cooling channel 130 causes sufficient cooling of the exhaust gases before exiting the vent 132 into the environment such that lithium in the exhaust gases does not ignite when exposed to oxygen in the external environment of the battery containment assembly 100.

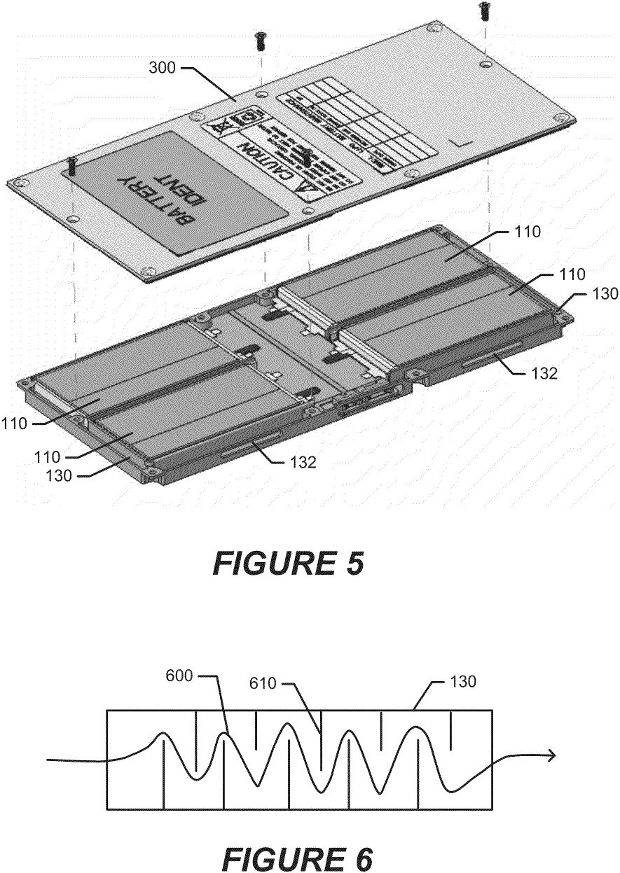

FIG. 5 illustrates a disassembled view of an alternative configuration of a battery containment assembly 100 showing various components configured in accordance with some embodiments of the present disclosure for powering an electronic device. Referring to FIG. 5, each of the lithium-ion batteries 110 comprises a major dimension and minor dimension, and a length of the cooling channel 130 extends at least as long as the minor dimension. In some embodiments, the length of the cooling channel extends at least as long as the major dimension. In some embodiments, the length of the cooling channel extends at least as long as triple the major dimension.

In some embodiments, the cooling channel 130 is thermally coupled to a heatsink, e.g., a bottom surface of the assembly 100 and the cover 300, to provide rapid transfer of heat from exhaust gases to the heatsink and enable sufficient cooling to prevent ignition when exhausted to the environment. Thus, in some embodiments, a length of the cooling channel is thermally coupled to a heat sink having a thermal mass that functions to cool the temperature of the gasses exhausted from the lithium-ion batteries 110 during the thermal runaway condition.

FIG. 6 illustrates a schematic side view of a cooling channel 130 configured with a serpentine shaped gas flow pathway in accordance with some embodiments of the present disclosure. The structure of the cooling channel 130 in FIG. 6 also lengthens the gas flow pathway and, thereby increases the heat transfer from the gasses to the surfaces of the cooling channel 130. In some embodiments, the cooling channel 130 has a serpentine shaped gas flow pathway 600 through which the gas flows toward the vent 132 to exhaust outside of the lithium-ion battery casing 120, the serpentine shaped gas flow pathway 600 is configured to cool the temperature of the gas by transferring heat from the gas to surfaces and structure of the cooling channel 130.

Referring to FIG. 6, in some embodiments, the battery containment assembly 100 includes a plurality of airflow fins 610 spaced apart along the cooling channel 130 and arranged in a sequence to extend inwardly from alternating opposite interior surfaces of the cooling channel 130 to force the gas flow to thermally interact with more surface area of the cooling channel 130 while being diverted back and forth toward opposite interior surfaces of the cooling channel 130.

In some embodiments, the plurality of airflow fins 610 extend inwardly from side surfaces of the cooling channel 130 and extend downward from a top surface of the cooling channel 130 at least 50% of a distance between the top surface and a bottom surface of the cooling channel 130.

In some embodiments, the cooling channel 130 includes segments. Each segment has a length at least as long as a minor dimension of the least one lithium-ion battery 110. In one embodiment, the cooling channel 130 comprises at least 3 of the segments. Each of the at least 3 of the segments has a length at least as long as a major dimension of the least one lithium-ion battery 110. In the example embodiment illustrated in FIG. 4, the serpentine pathway of the cooling channel 130 includes segments 400a, 400b, and 400c which alternately reverse the ducted direction of the ducted gasses while traversing from one of the left-side batteries 110 to the vent 132.

Some embodiments are directed to other shapes formed by the cooling channel 130 to duct the exhausting gasses to lengthen the cooling channel 130 and increase the effectiveness of the cooling channel 130. The cooling channel 130 may include bumps on the interior of the cooling channel 130, sawtooth shapes on the interior of the cooling channel 130, or other shapes causing mixing of the gas as it flows through the cooling channel 130.

In some embodiments, the battery containment assembly 100 also includes a plurality of airflow bumps spaced apart along the cooling channel 130 and each extending inwardly from alternating side interior surfaces of the cooling channel 130 to force the airflow to thermally interact with more surface area of the cooling channel 130 while being diverted back and forth toward opposite sides of the cooling channel 130. The bumps may function to cause turbulent non-laminar flow of the gasses through the segments of the channels and thereby increase heat transfer from the gasses to the surfaces of the channels.

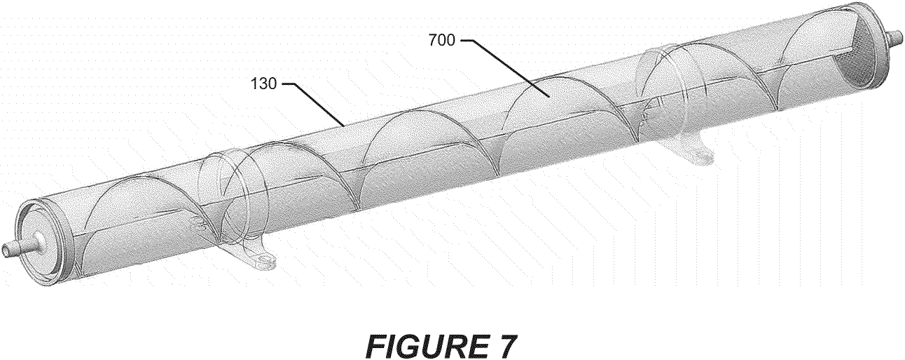

FIG. 7 is a schematic isometric view of a cooling channel 130 configured with a spiral shaped structure 700 to create a spiral gas flow pathway in accordance with some embodiments of the present disclosure. The spiral gas flow pathway of the cooling channel 130 increases turbulence of the gas flow and increases the surface area that contacts the gasses, which in-turn increases the heat transfer to the cooling channel 130 and associated gas cooling capability.

Referring to FIG. 7, the spiral shaped structure 700 is enclosed by a tube with an input end connected to receive exhaust gasses from the lithium-ion batteries 110 and an opposite output end connected to either the input end of another spiral shaped structure 700 or to a vent 132.

In some embodiments, the spiral shaped structure 700 of the cooling channel 130 is enclosed by a cylindrical-shaped tube. The spiral shaped structure 700 may have a diameter about equal to an interior diameter of the cylindrical tube to force the gasses to flow along the spiral pathway created by the structure 700.

Although some embodiments are described in the context of a spiral structure being used in combination with a cylindrical tube, other spiral shapes may be used, such as rectangular shaped spiral or other shape spiral pathways. For example, a ramp shaped serpentine shaped gas flow pathway may be provided by flat surfaces that extend at angles alternating upward and downward toward the top and bottom surfaces, respectively, of a rectangular shaped enclosure to force airflow to meander upward near a top surface of the enclosure and then dive downward near a bottom surface of the ensure, to ensure that the gas travels a sufficient length and/or time in the cooling channel to lower the temperature of the gas lower than the ignition temperature of the gas while flowing from the battery 110 to the vent 132.

Some embodiments are directed to lowering temperature by providing a larger volume section that the gasses enter from the serpentine shaped channel before exiting the vent 132. For example, FIGS. 1, 3, and 5 illustrate the cooling channel 130 having a larger volume section where the gasses enter before exiting the vent 132. Providing a larger volume section before the gasses exit the vent 132 may function to decrease pressure of the gasses and correspondingly cool temperature of the gasses before exiting the vent 132.

In some embodiments, the cooling channel 130 comprises a wider cross-section configured to have a width greater than any cross-section of a major section of the cooling channel 130 upstream of the flowing gasses to further reduce the temperature of the gasses flowing through the wider cross-section by reducing pressure of the gas by expansion of the gas flow into the wider cross-section the cooling channel 130.

Some embodiments are directed to providing a seal between the cooling channel 130 and the batteries 110 which reduces or prevents presence of a sufficient level of oxygen against the batteries 110 that would otherwise enable some combustion to occur in the hot lithium gas exhausted by a battery during thermal runaway before entering the cooling channel. The seal is configured to burst when the gas pressure reaches a threshold level as the battery 110 experiences thermal runaway conditions, and by bursting the gasses push through the seal into the cooling channel 130.

Some other embodiments are directed to providing a membrane covering the vent 132 and configured to seal a non-reactive gas throughout the cooling channel 130. The nonlithium component of the gas exhausted by the reactive gas is selected to not react with a of the by thermal runaway battery 110 and prevent combustion of the lithium gas component in the cooling channel 130 and thereby improve cooling of the gasses being ducted through the cooling channel 130.

The membrane is configured to burst when the gas pressure in the cooling channel 130 reaches a threshold level as the battery 110 experiences thermal runaway conditions, and by bursting the gasses push through the seal and exit the vent 132.

In some embodiments, the non-reactive with lithium gas comprises at least one of argon, helium, nitrogen, and neon.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented in entirely hardware without software or may be a combination of hardware and software executed by a computer controller.

It is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A battery containment assembly for powering an electronic device, the battery containment assembly comprising:
at least one lithium-ion battery;
a battery casing enclosing the at least one lithium-ion battery and having a cooling channel extending from a vent of the battery casing to the at least one lithium-ion battery, the cooling channel configured to vent any gas exhausted by the at least one lithium-ion battery to mix with air outside of the battery casing and to lower a temperature of the gas exhausted from the at least one lithium-ion battery during a thermal runaway condition of the at least one lithium-ion battery before the gas exits the vent.

2. The battery containment assembly of claim 1, wherein the cooling channel comprises a material and shape configured to perform conductive heat transfer from the gas so the temperature of the gas is below a spontaneously combustion temperature of a lithium gas component when exposed to oxygen in the air outside the battery casing.

3. The battery containment assembly of claim 2, wherein the cooling channel is configured to cool the gas exiting the vent to below 180° C. to prevent the lithium gas component of the gas from spontaneously combusting when exposed to oxygen in the air outside the battery casing.

4. The battery containment assembly of claim 1, wherein:
the at least one lithium-ion battery comprises a major dimension and minor dimension; and
a length of the cooling channel extends at least as long as the minor dimension.

5. The battery containment assembly of claim 4, wherein the cooling channel extends at least as long as the major dimension.

6. The battery containment assembly of claim 5, wherein the length of the cooling channel extends at least as long as triple the major dimension.

7. The battery containment assembly of claim 1, wherein the cooling channel comprises a thermally conductive material having a thermal mass that functions to cool the temperature of the gas exhausted from the at least one lithium-ion battery during the thermal runaway condition.

8. The battery containment assembly of claim 7, wherein the cooling channel is thermally coupled to a heat sink having a thermal mass that functions to cool the temperature of the gas exhausted from the at least one lithium-ion battery during the thermal runaway condition.

9. The battery containment assembly of claim 1, wherein the cooling channel is thermally coupled to a thermally conductive component of the electronic device having a thermal mass that functions to cause changes to the temperature of the gas exhausted from the at least one lithium-ion battery during the thermal runaway condition.

10. The battery containment assembly of claim 1, wherein the cooling channel has a serpentine shaped gas flow pathway through which the gas flows toward the vent to exhaust outside of the lithium-ion battery casing, the meandering gas flow pathway is configured to cool the temperature of the gas by transferring heat from the gas to surfaces and structure of the cooling channel.

11. The battery containment assembly of claim 10, further comprising:
a plurality of airflow fins spaced apart along the cooling channel and arranged in a sequence to extend inwardly from alternating opposite interior surfaces of the cooling channel to force the gas flow to thermally interact with more surface area of the cooling channel while being diverted back and forth toward opposite interior surfaces of the cooling channel.

12. The battery containment assembly of claim 11, wherein:
the plurality of airflow fins extend inwardly from side surfaces of the cooling channel and extend downward from a top surface of the cooling channel at least 50% of a distance between the top surface and a bottom surface of the cooling channel.

13. The battery containment assembly of claim 10, wherein:
the cooling channel comprises segments; and
each segment has a length at least as long as a minor dimension of the least one lithium-ion battery.

14. The battery containment assembly of claim 13, wherein:
the cooling channel comprises at least 3 of the segments; and
each of the at least 3 of the segments has a length at least as long as a major dimension of the least one lithium-ion battery.

15. The battery containment assembly of claim 10, further comprising:
a plurality of airflow bumps spaced apart along the cooling channel and each extending inwardly from alternating side interior surfaces of the cooling channel to force the airflow to thermally interact with more surface area of the cooling channel while being diverted back and forth toward opposite sides of the cooling channel.

16. The battery containment assembly of claim 10, further comprising:
a spiral structure provided in the cooling channel extending a major axis of the cooling channel along a gas flow pathway between the at least one lithium-ion battery and the vent, the spiral structure directing the gas flow in a spiraling pathway.

17. The battery containment assembly of claim 16, wherein the cooling channel is a cylindrical tube containing the spiral structure having a diameter about equal to an interior diameter of the cylindrical tube and extends between opposite ends of the cylindrical tube.

18. The battery containment assembly of claim 1, the cooling channel comprises a wider cross-section configured to have a width greater than any cross-section of a major section of the cooling channel upstream of the flowing gas to further reduce the temperature of the gas flowing through the wider cross-section by reducing pressure of the gas by expansion of the gas flow into the wider cross-section the cooling channel.

19. The battery containment assembly of claim 1, further comprises:
a membrane covering the vent and configured to seal a non-reactive gas throughout the cooling channel, the non-reactive gas does not react with a lithium component of the gas exhausted by the at least one lithium-ion battery to combust while mixing in the cooling channel, the membrane being further configured to burst to allow exhaustion of the gas exhausted by the at least one lithium-ion battery upon pressure in the cooling channel reaching a threshold level.

20. The battery containment assembly of claim 19, wherein the non-reactive with lithium gas comprises at least one of argon, helium, nitrogen, and neon.
